(19) United States
(12) Patent Application Publication
(10) Pub. No.: US 2007/0056296 A1
(43) Pub. Date: Mar. 15, 2007

(54) Liquid dispensing system and method

(76) Inventor: Thomas Gagliano, Luxembourg Grund (LU)

Correspondence Address: MICHAEL BEST & FRIEDRICH, LLP, 100 E WISCONSIN AVENUE, MILWAUKEE, WI, 53202, US

(21) Appl. No.: 11/225,806

(22) Filed: Sep. 12, 2005

(51) Int. Cl. F25B 21/02; B67D 5/62

(52) U.S. Cl. 62/3.64; 62/3.7; 62/389

(57) ABSTRACT

System and method of cooling and dispensing a liquid, such as a beverage. The system can include a liquid source, a cooling reservoir, a dispensing valve, and a liquid conduit. The liquid conduit can connect the liquid source to the dispensing valve. The liquid conduit can be constructed of a thermally-conductive material. The liquid conduit can pass through the cooling reservoir. The invention can include a method of providing cooled liquids to a dispensing valve. The method can include maintaining ice and a cooling liquid in a cooling reservoir near the dispensing valve, pumping liquid through a thermo conductive conduit positioned in the ice and cooling liquid, and pumping the liquid out of the dispensing valve.

### FIELD OF THE INVENTION

The invention generally relates to systems and methods for dispensing liquids, including beverages such as beer.

### BACKGROUND OF THE INVENTION

In many parts of the world, kegs of beer are kept at room temperature and cooled during dispensing. A line runs from the keg to an in-line cooler which cools the beer to a desired temperature. A hose then runs from the in-line cooler to the dispense point. When a beer is being dispensed, relatively warm beer runs from the keg to the in-line cooler where it is chilled to a desired temperature. The cooled beer then travels through the hose to the dispense point. The beer that is in the hose after the cooler can warm to ambient temperature if it remains in the hose for a sufficient period of time. This can result when there is a sufficient period of time between beers being dispensed. As a result, the volume of beer that is in the hose can be dispensed at a significantly warmer temperature than is desired. In some markets, “pythons” or cooled beverage lines are used to alleviate this problem.

The current trend in the beer industry is toward a dramatic increase in the number of dispense points and a corresponding decrease in the amount of beverage dispensed from each of these dispense points individually. Because of this decrease in the amount of beer dispensed from each dispense point, a significantly greater number of these beers are served at a warmer temperature than desired, because the beverage has been in the hose for a relatively longer period of time than in the past.

Further, the cost of each installation of a dispensing point becomes more critical with the trend toward more dispensing points and each dispensing point dispensing less volume. With the reduced volume dispensed at each dispense point, a user's return on investment can be significantly longer than in the past.

### SUMMARY OF THE INVENTION

In some embodiments, the invention can provide a liquid cooling and dispensing system including a liquid source, a cooling reservoir, a dispensing valve, and a liquid conduit. The liquid conduit can connect the liquid source to the dispensing valve. The liquid conduit can be constructed of a thermally-conductive material. The liquid conduit can pass through the cooling reservoir.

Some embodiments of the liquid distribution system include a cooling reservoir at least partially filled with a cooling liquid and an insulating material coupled to the cooling reservoir. The system can also include an ice forming module positioned in the cooling reservoir in thermal communication with the cooling liquid. The ice forming module can include a thermoelectric cooler (also referred to as a Peltier cooler) and an ice growing appendage. The system can include a liquid conduit positioned in the cooling reservoir, and the liquid conduit can be coupled to a dispensing valve.

The invention can include a method of providing cooled liquids to a dispensing valve. The method can include maintaining ice and water in a cooling reservoir near the dispensing valve, pumping liquid through a thermo conductive conduit positioned in the ice and water, and pumping the liquid out of the dispensing valve.

### BRIEF DESCRIPTION OF THE DRAWINGS

FIGS. 1A, 1B, 1C, and 1D are front, side, back, and top views of a beverage dispensing tower according to one embodiment of the invention.

FIG. 2 is a side cross-sectional view of the beverage dispensing tower of FIG. 1.

FIG. 3 is a side cross-sectional view of an ice forming module according to one embodiment of the invention.

FIGS. 4A, 4B, and 4C are side cross-sectional views of ice forming modules coupled to a cooling reservoir according to embodiments of the invention.

FIGS. 5A, 5B, 5C, 5D, 5E, and 5F are side and top views of ice growing appendages according to embodiments of the invention.

FIGS. 6A and 6B are side cross-sectional views of insulation structure according to embodiments of the invention.

FIGS. 7A, 7B, and 7C are side cross-sectional views of insulation methods and materials according to embodiments of the invention.

FIGS. 8A, 8B, 8C, 8D, 8E, 8F, and 8G are side cross-sectional views of liquid conduit structures according to embodiments of the invention.

FIGS. 9A, 9B, 9C, and 9D are side and top views of cooling reservoirs according to embodiments of the invention.

FIGS. 10A, 10B, 10C, and 10C are side cross-sectional views of agitators according to embodiments of the invention.

FIG. 11 is a side cross-sectional view of a cooling reservoir according to one embodiment of the invention.

FIG. 12 is a perspective cross-sectional view of a thermoelectric cooler and ice growing appendage of a cooling reservoir according to one embodiment of the invention.

FIG. 13 is a side view of a beverage dispensing tower with multiple dispensing valves according to one embodiment of the invention.

FIG. 14 is a perspective view of a beverage dispensing tower according to one embodiment of the invention.

FIGS. 15A and 15B are side views of cooling reservoirs according to embodiments of the invention.

FIG. 16 is a side view of a cooling reservoir according to one embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, whether direct or indirect.

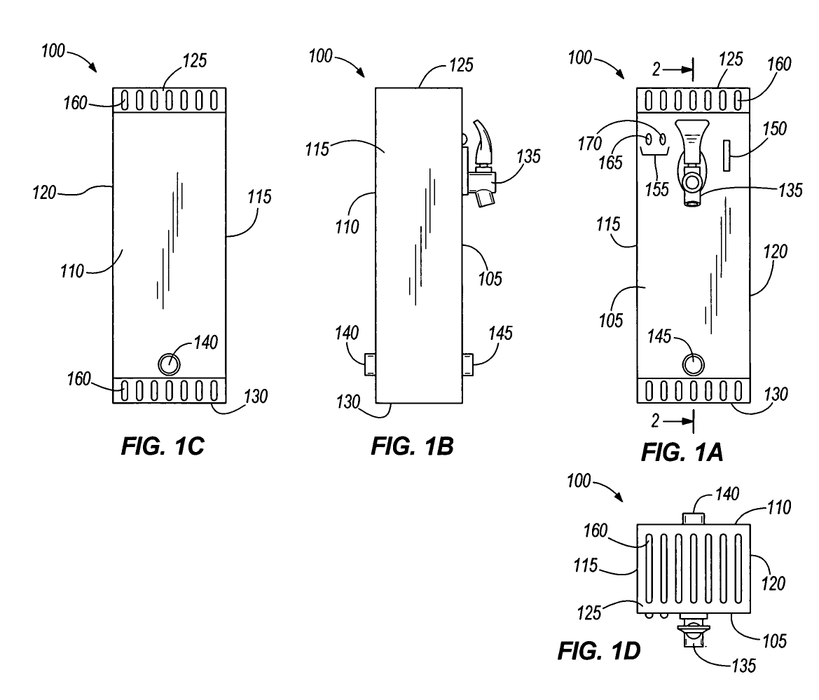

FIGS. 1A-1D illustrate front, side, back, and top views of one embodiment of a beverage dispensing tower 100 for cooling a beverage before dispensing the beverage. In some embodiments, the beverage dispensing tower 100 can include a complete beverage cooling system that can be housed within a single tower and mounted on a counter or bar. In some embodiments, the beverage can be cooled substantially immediately before dispensing the beverage. Although various embodiments of the invention are described with respect to beverages (such as beer), each embodiment of the invention is also suitable for various types of liquids. The beverage dispensing tower 100 can have a rectangular or circular cross-sectional shape or one or more other suitable cross-sectional shapes in order to accommodate various internal components and/or in order to be consistent with other beverage dispensing tower geometries. The beverage dispensing tower 100 can include a front wall 105, a back wall 110, a first side wall 115, a second side wall 120, a top 125, and a bottom 130. The beverage dispensing tower 100 can include a dispensing valve 135 coupled to the front wall 105, in some embodiments, from which a beverage can be dispensed into a glass, mug, or other container. The beverage can enter the beverage dispensing tower 100 via an inlet coupling 140, which can be positioned on the back of the beverage dispensing tower 100, in some embodiments. In other embodiments of the beverage dispensing tower 100, the inlet coupling 140 can be located on the bottom, front, top, or another suitable point on the beverage dispensing tower 100.

A drain plug 145 can be coupled to the beverage dispensing tower 100 to enable draining of a cooling liquid from the beverage dispensing tower 100. The drain plug 145 can be located on any side or the bottom of the beverage dispensing tower 100. Generally, the drain plug 145 can be located near the bottom of the beverage dispensing tower 100 to promote drainage.

In some embodiments, a site glass 150 can be coupled to the front wall 105 of the beverage dispensing tower 100 to enable a user to determine if the level of cooling liquid in the beverage dispensing tower 100 is sufficient. Some embodiments of the beverage dispensing tower 100 can include a level sensor to detect the level of the cooling liquid and an indicator to alert the user of low levels of cooling liquid. Some embodiments can include a fill spout (not shown) to allow a user to add additional cooling liquid should it be determined that the level of cooling liquid in the beverage dispensing tower 100 is insufficient. In some embodiments, additional sensors located within the cooling volume (e.g., ice/water) can sense the volumetric expansion related to ice formation and infer the volume of ice present, thus providing logic inputs to cycle a cooling cycle circuit on and off.

In some embodiments, a set of indicator light emitting diodes (“LED”) 155 can be coupled to the front wall 105 of the beverage dispensing tower 100 to indicate that the beverage is cool enough for dispensing and/or that the beverage is not cool enough for dispensing.

Air vents 160 can be included in one or more of the top wall 125, the front wall 105, and the back wall 110 for removing heat from the beverage dispensing tower 100. Other embodiments can include vents in other areas of the beverage dispensing tower 100, such as the first side wall 115 and/or the second side wall 120. In some embodiments, heat removal through aspiration ports or air vents can be facilitated by forced convection, such as using fans, or by natural convection.

A container (not shown) holding a beverage, such as beer, can be coupled to the beverage inlet coupling 140 under pressure. The beverage can be at room temperature (approximately 25° C.). The beverage can flow through the beverage dispensing tower 100 to the dispensing valve 135. While in the beverage dispensing tower 100 the beverage can be cooled. Should the beverage be cooled sufficiently, a green indicator LED 165 can turn on. When a user opens the dispensing valve 135, the cooled beverage can flow out of the dispensing valve 135 and into a container held by the user. In some embodiments, the beverage exiting the dispensing valve 135 can be cooled to 5-8° C. Should the system not be fully recovered from previous dispenses, or thermal loads, resulting in the next beverage not be sufficiently cooled, a red indicator LED 170 can be turned on and the green indicator LED 165 can be turned off. Once the system has been dormant for the required period of time for the system to thermally “recover” (with “recover” being defined by an increased water temperature melting some of the ice mass and bringing the water temperature down to an acceptable value), the green LED can be turned on again as the red LED is turned off. This switching can be driven by a temperature switch located within the cooling volume (e.g., ice/water).

A common container for dispensing beer can have a volume of 0.3 liters. In some embodiments, the beverage dispensing tower 100 can dispense two to seven 0.3 liter cooled beverages before the beverage exiting the dispensing valve 135 is at a temperature that is not sufficiently cool. At this point, the red indicator LED 170 can be turned on. Following a delay of approximately 20 seconds, in some embodiments, the beverage in the beverage dispensing tower 100 can be cooled sufficiently, the red indicator LED 170 can be turned off, and the green indicator LED 165 can be turned on. At this point, another two to seven 0.3 liter cooled beverages can be dispensed.

In one embodiment, after dispensing two to seven beverages, waiting 20 seconds, and dispensing two to seven more beverages, enough cooling capacity may have been removed from the beverage dispensing tower 100 so as to require a 90 second delay before any more sufficiently-cooled beverages can be poured (e.g., when a keg is stored at 35° C.). However, when a keg is stored at 25° C., the delay period can be less than 90 seconds. During this recharging or recovery period, the red indicator LED 170 can be turned on and the green indicator LED 165 can be turned off to indicate to a user that the beverage is not sufficiently cooled. Once enough cooling capacity has returned to the system, the green indicator LED 165 can be turned on and the red indicator LED 170 can be turned off to indicate to the user that beverages can be dispensed at the desired temperature. Following any period in which no beverage has been dispensed from the beverage dispensing tower 100 for 90 seconds or more, the beverage dispensing tower 100 can have sufficient cooling capacity to dispense two to seven beverages, delay 20 seconds, and dispense two more beverages at the desired temperature.

Although some embodiments allow two to seven beverages to be dispensed, other embodiments allow beverage to be dispensed continuously until the ice mass is substantially or completely melted.

In some embodiments of the beverage dispensing tower 100, the beverage entering the beverage dispensing tower 100 may be at a temperature of 17° C. Various sized containers (0.3 liter, 0.5 liter, and 1.0 liter) can be used for receiving the dispensed beverage. Following the dispensing of the each container full of beverage, a delay of 10-15 seconds can occur (e.g., to deliver the beverage to a customer). Over a 35 minute period, the beverage dispensing tower 100 can dispense 22 liters of beverage at 5-8° C. with no further delays due to insufficient cooling capacity.

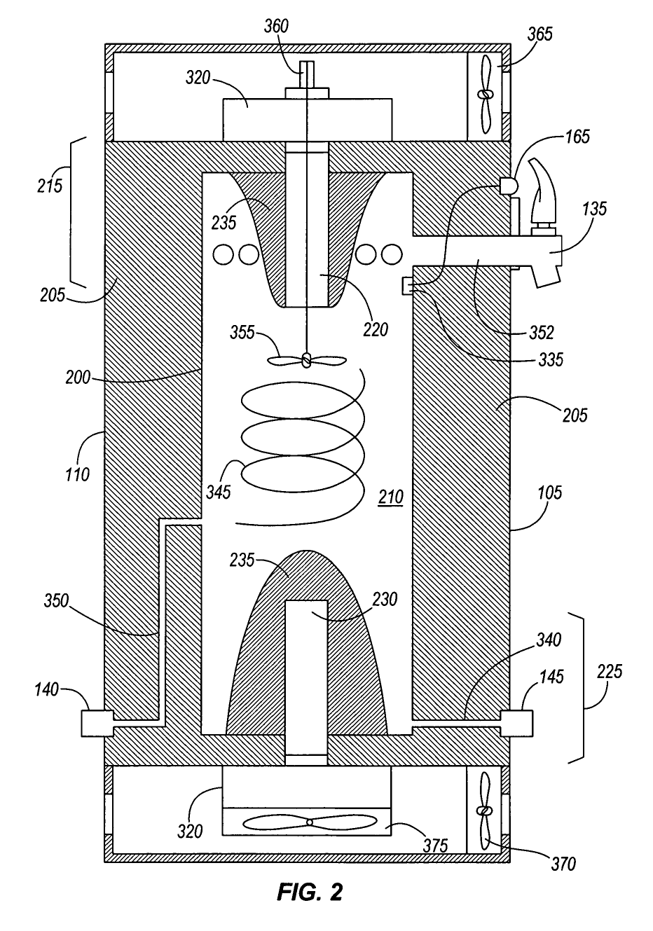

FIG. 2 illustrates a cross-section of one embodiment of the beverage dispensing tower 100. A cooling reservoir 200 can be surrounded by insulation 205 and filled with water 210. The insulation 205 can be any thermally insulating material, such as foam polyurethane, that provides the level of thermal insulation necessary to achieve the cooling desired. In some embodiments, a vacuum or one or more air layers can be used as thermal insulation in conjunction with other media, resulting in a high net resistance to thermal conductivity. Additionally, other liquids, such as glycol or a glycol-water mixture, can be used in place of the water 210 to achieve different cooling characteristics. A top ice forming module 215 can be positioned at the top of the cooling reservoir 200 with a first ice growing appendage (“IGA”) 220 positioned within the cooling reservoir 200. A bottom ice forming module 225 can be positioned at the bottom of the cooling reservoir 200 with a second ice growing appendage 230 positioned within the cooling reservoir 200. During operation of the beverage dispensing tower 100, the ice growing appendages 220 and 230 can cool and then freeze the water 210 to form ice 235. In some embodiments, heat pipes can be used to construct the ice growing appendages with lower temperature gradients, resulting in more controlled ice growth and geometry. The highly-effective thermal conductivity of the heat pipe results in a more isothermal ice growing appendage, which facilitates more uniform ice formation over time over the ice growing appendage surface.

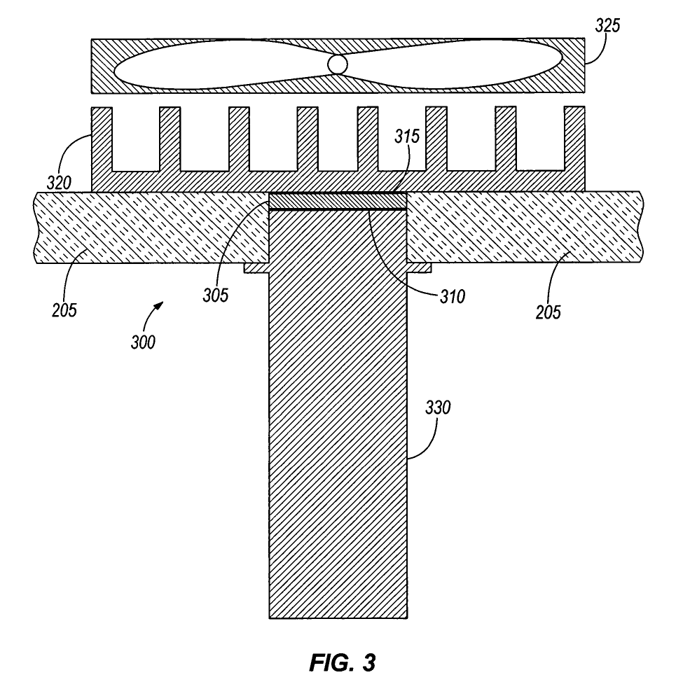

FIG. 3 illustrates one embodiment of an ice forming module 300. A thermoelectric cooler (“TEC” or Peltier cooler) 305 can provide the cooling capability. A TEC 305 is a semiconductor device which, when powered by a direct current (“DC”), has a first cool side 310 that is cooler than the surrounding ambient temperature and a second warm side 315 that is warmer than the surrounding ambient temperature. Application of different levels of DC voltage to the TEC 305 can result in different thermal characteristics (e.g., a higher voltage can result in greater cooling). A switching style DC power supply (e.g., 12 Volt DC and various Watts) can be used to power the TEC 305 and can achieve higher operating efficiencies.

A heat sink 320 (e.g., constructed of aluminum or some other thermally-conductive material) can be positioned adjacent the second warm side 315 of the TEC 305 in thermal communication with the TEC 305. A thermal grease can be applied between the heat sink 320 and the TEC 305 to improve the conduction of heat away from the TEC 305. Additionally, a fan 325 can be mounted adjacent the heat sink 320 to assist in conducting heat away from the TEC 305. Certain embodiments of the ice forming module 300 can have thermal characteristics wherein sufficient heat dissipation can occur at the heat sink 320 such that the fan 325 may not be necessary.

An ice growing appendage 330 (e.g., constructed of aluminum or some other thermally-conductive material) can be mounted adjacent and in thermal communication with the first cool side 310 of the TEC 305. Again, thermal grease can be used between the TEC 305 and the ice growing appendage 330 to improve the thermal conductivity between the TEC 305 and the ice growing appendage 330. To achieve desired thermal efficiency it may be necessary to provide insulation 205 around the ice growing appendage 330 for a distance away from the heat sink 320 and TEC 305. In some embodiments, an even surface on the ice growing appendage 330 can result in efficient thermal conductivity with the TEC 305.

When a DC current is applied to the TEC 305, the second warm side 315 of the TEC 305 will generate a positive temperature relative to the ambient temperature which can be dissipated by the heat sink 320 and fan 325. The first cool side 310 of the TEC 305 can cool the ice growing appendage 330 relative to the ambient temperature. The ice growing module 300 can be mounted to the cooling reservoir 200 of the beverage dispensing tower 100 and the ambient temperature can be the temperature of the water 210. Because of the insulation 205 that can be positioned around the cooling reservoir 200, the temperature of the water 210 can continue to drop, which can result in a lower ambient temperature on the first cool side 310 of the TEC 305. If the thermal insulation around the cooling reservoir 200 is sufficient, the ambient temperature of the water 210 can continue to drop until the water 210 around the ice growing appendage 330 freezes. Eventually, the ice 235 around the ice growing appendage 330 can become thick enough that the ice 235 can insulate the water 210 sufficiently from the ice growing appendage 330 such that no more water 210 can freeze.

As shown in FIG. 2, in some embodiments, a temperature sensor 335 can be positioned in the water 210 of the cooling reservoir 200 to determine if the beverage dispensing tower 100 has sufficient cooling capacity. As also shown in FIG. 2, a drain tube 340 can couple the cooling reservoir 200 to the drain plug 145 on the front wall 105 of the beverage dispensing tower 100.

A thermally-conductive liquid conduit 345 suitable for use with consumable liquids (e.g., stainless steel beverage tubing) can be positioned within the cooling reservoir 200. The liquid conduit 345 can be coiled tubing and can be coupled to the inlet coupling 140 via a hose 350 and to the dispensing valve 135 via a tube 352.

In some embodiments, a stirring agitator 355 can be positioned within the cooling reservoir 200 to move the water 210 so that the temperature of the water 210 is substantially consistent throughout the cooling reservoir 200. The stirring agitator 355 can be driven by an agitator motor 360 which can be positioned external to the cooling reservoir 200, in some embodiments. In some embodiments, other mechanical fluid agitators can be used, such as an external rotary magnetic field that excites coherent movement of suspended particles within the fluid volume and/or external fluid pumps.

A first cooling fan 365 can move air over the heat sink 320 of the upper ice forming module 215. The first cooling fan 365 can draw air in through the vents 160 on the front wall 105 of the beverage dispensing tower 100 and can force the air across the heat sink 320. The heated air can exit the beverage dispensing tower 100 via the vents 160 on the top wall 125 or the back wall 110 of the beverage dispensing tower 100.

A second cooling fan 370 can move air across the heat sink 320 of the lower ice forming module 225. The second cooling fan 370 can draw air in through the vents 160 on the front wall 105 of the beverage dispensing tower 100 and can force the air across the heat sink 320. The heated air can exit the beverage dispensing tower 100 via the vents 160 on the back wall 110 of the beverage dispensing tower 100. Additionally or alternatively, a fan 375 can be mounted adjacent to the heat sink 320 to draw heat off the heat sink 320.

To sufficiently cool the beverage in the liquid conduit 345 of beverage dispensing tower 100 at a desired rate, a certain proportion and structure of ice 235 and water 210 within the cooling reservoir 200 can be used. Because the beverage can freeze at or near the temperature of the ice 235, in some embodiments, the liquid conduit 345 can be positioned only in the water 210 and not in the ice 235. In some embodiments, the liquid conduit 345 can be partially or completely embedded within a solid ice mass (e.g., ice 235). It may be necessary to have a certain volume of water 210, and thus sufficient thermal capacity, to cool the beverage to a desired temperature at a desired rate. Excess water could result in inefficiency and an inability to maintain desired temperatures. Not enough water could result in insufficient thermal capacity. Different methods of controlling the structure and quantity of ice 235 include positioning one or more ice forming modules 300 in particular places, modifying the size and shape of the ice growing appendage 330, modifying the structure and amount of insulation 205, modifying the quantity and structure of the liquid conduit 345, modifying the size and shape of the cooling reservoir 200, and modifying the type, position, and operation of an agitator 355.

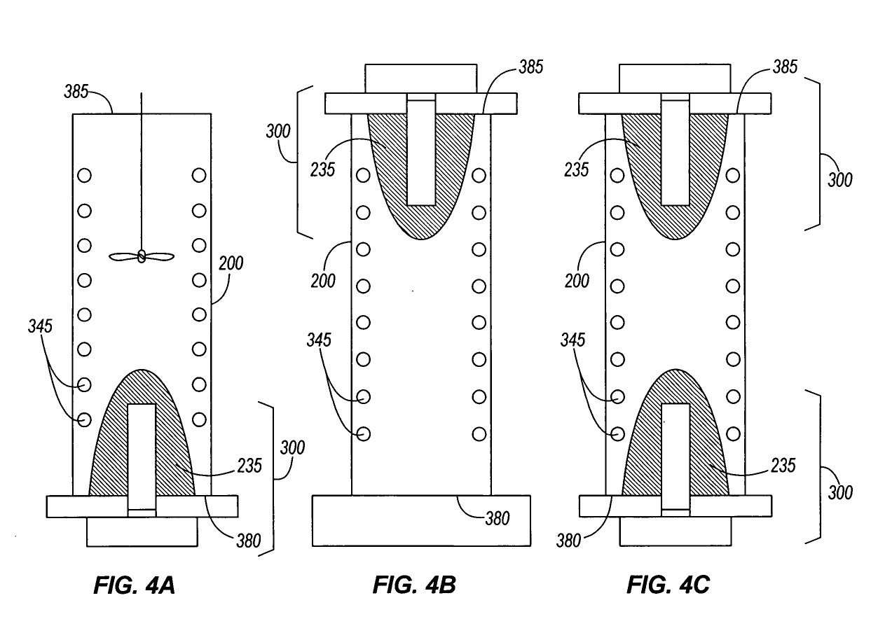

FIGS. 4A-4C illustrate several embodiments of cooling reservoirs 200 with different configurations of ice forming modules. FIG. 4A illustrates a single ice forming module 300 positioned adjacent a bottom 380 of the cooling reservoir 200. FIG. 4B illustrates a single ice forming module 300 positioned adjacent an end cap or a top portion 385 of the cooling reservoir 200. FIG. 4C illustrates a double ice forming module 300 formation with one ice forming module 300 positioned adjacent the bottom 380 of the cooling reservoir 200 and one ice forming module 300 positioned adjacent the top portion 385 of the cooling reservoir 200. Other configurations are possible, depending on the desired cooling operation, including one or more ice forming modules 300 on the bottom, top, or sides of the cooling reservoir 200.

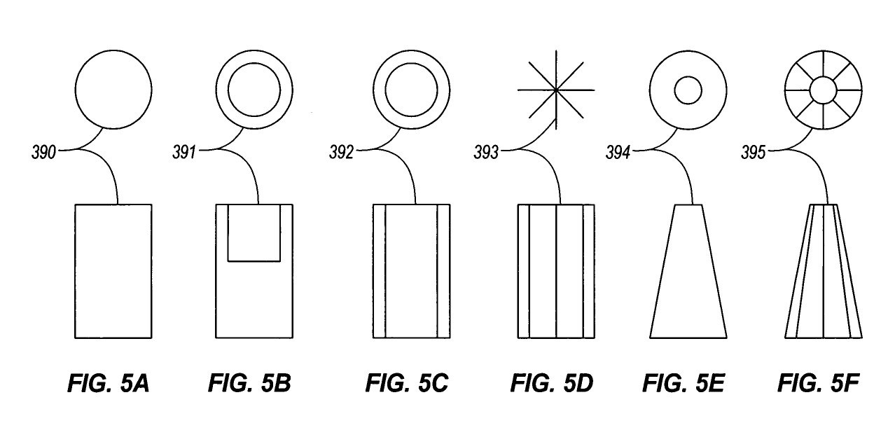

FIGS. 5A-5F illustrate several embodiments of the ice growing appendages 330. The embodiments shown include a cylinder shape (FIG. 5A), a semi-hollow cylinder shape (FIG. 5B), a tube shape (FIG. 5C), a star shape (FIG. 5D), a conical shape (FIG. 5E), and a conical star shape (FIG. 5F). The ice growing appendages 330 can also include other variations of shapes and sizes. When multiple ice forming modules 300 are used, the ice growing appendages 330 can be the same shape and/or size or they can be different shapes/sizes. In some embodiments, heat pipes can be used to form exotic, complex, and/or optimized geometries for the ice growing appendages.

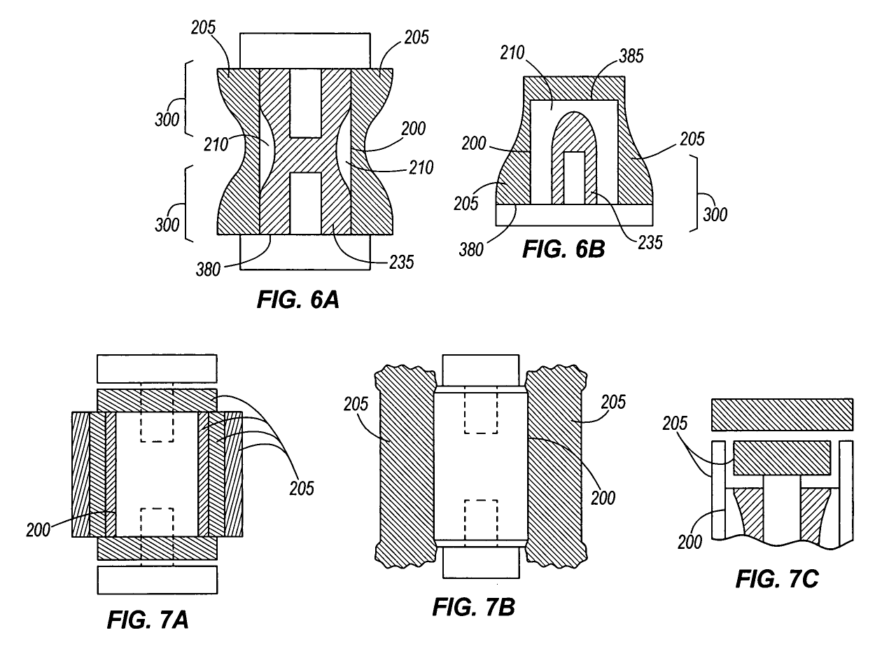

FIGS. 6A and 6B illustrate embodiments of configurations of insulation 205. FIG. 6A illustrates two ice forming modules 300, one on a top portion 385 of the cooling reservoir 200 and one on a bottom portion 380 of the cooling reservoir 200. Insulation 205 can be formed around the cooling reservoir 200 in an hour glass shape. This shape can prevent ice 235 from filling the entire cooling reservoir 200 and can leave an area of water 210 between the two ice growing appendages 330 in which the liquid conduit 345 can be positioned. FIG. 6B illustrates a single ice forming module 300 positioned in the bottom portion 380 of the cooling reservoir 200. Insulation 205 can be thinner near the top portion 385 of the cooling reservoir 200 to substantially prevent ice 235 from forming throughout the entire cooling reservoir 200. FIGS. 7A-7C illustrate embodiments of types of insulation 205. Possible configurations include wrapped sleeved layers (FIG. 7A), concentric foam (FIG. 7B), and an end-cap plug (FIG. 7C). Other embodiments of the beverage dispensing tower 100 may use a vacuum or an air gap as one or more of the insulating materials, which can allow for optimization of the total insulation thickness. In some embodiments, aluminum spacing can be used between the TEC's and end caps.

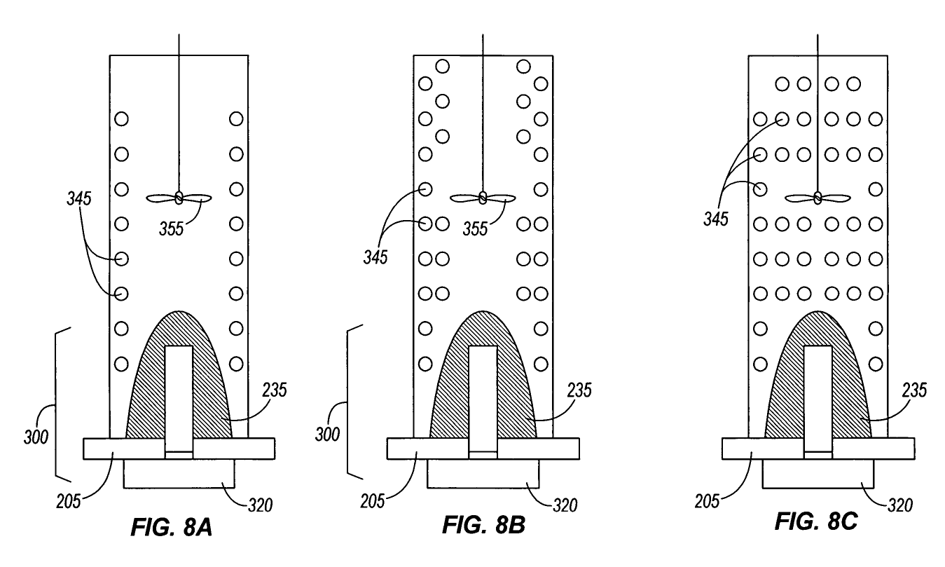

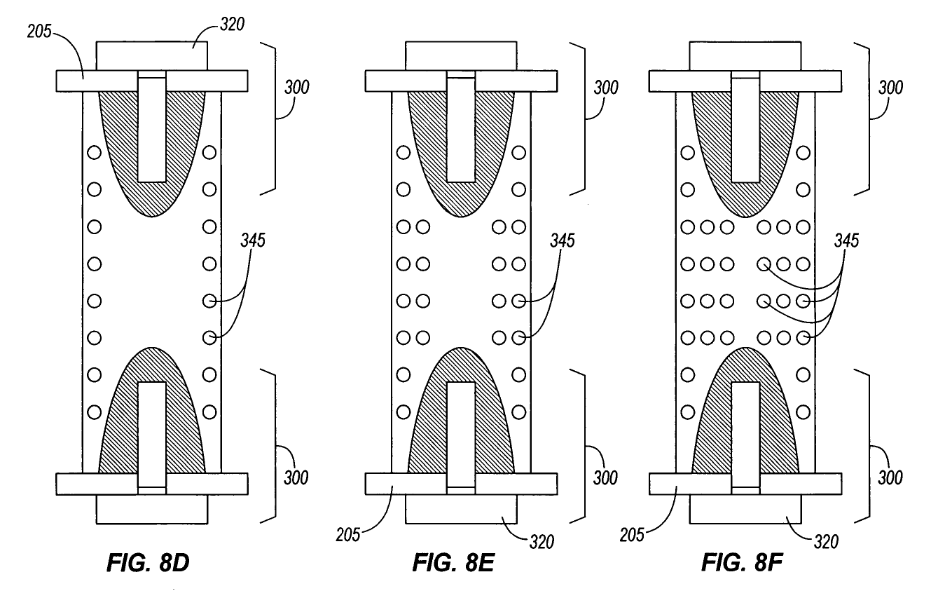

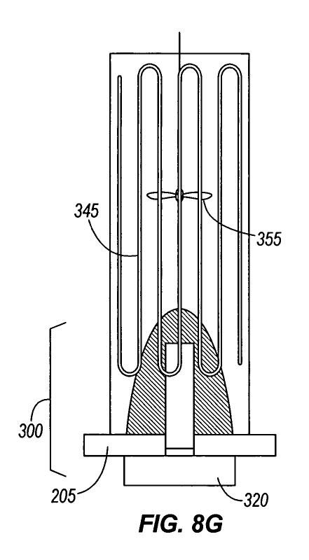

FIGS. 8A-8G illustrate embodiments of the liquid conduit 345 in cooling reservoirs 200 using one or more ice forming modules 300. FIGS. 8A and 8D illustrate an embodiment using a single coil of liquid conduit 345. FIGS. 8B and 8E illustrate embodiments using two concentric coils, and FIGS. 8C and 8F illustrate embodiments using three concentric coils. FIG. 8G illustrates an embodiment of the liquid conduit 345 in which the liquid conduit 345 can be formed in a serpentine shape. Other suitable configurations can be used for the liquid conduit 345 provided the liquid conduit 345 is of sufficient length and diameter to ensure enough volume of beverage can be enclosed within the cooling reservoir 200 to ensure the desired cooling of the beverage can be achieved. In some embodiments, the liquid conduit 345 can include a first coil with a smaller, denser coil positioned inside of the first coil, and the beverage can flow inside of the first coil and outside of the second coil.

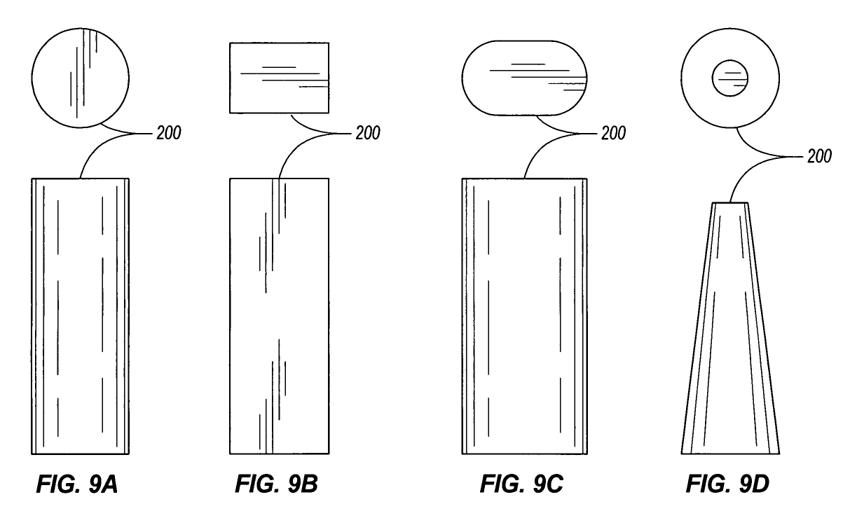

FIGS. 9A-9D illustrate embodiments of the cooling reservoir 200 having different shapes. One embodiment can include a cylindrical shape (FIG. 9A); however, other shapes can be used including a rectangular shape (FIG. 9B), an oval shape (FIG. 9C), and a conical shape (FIG. 9D).

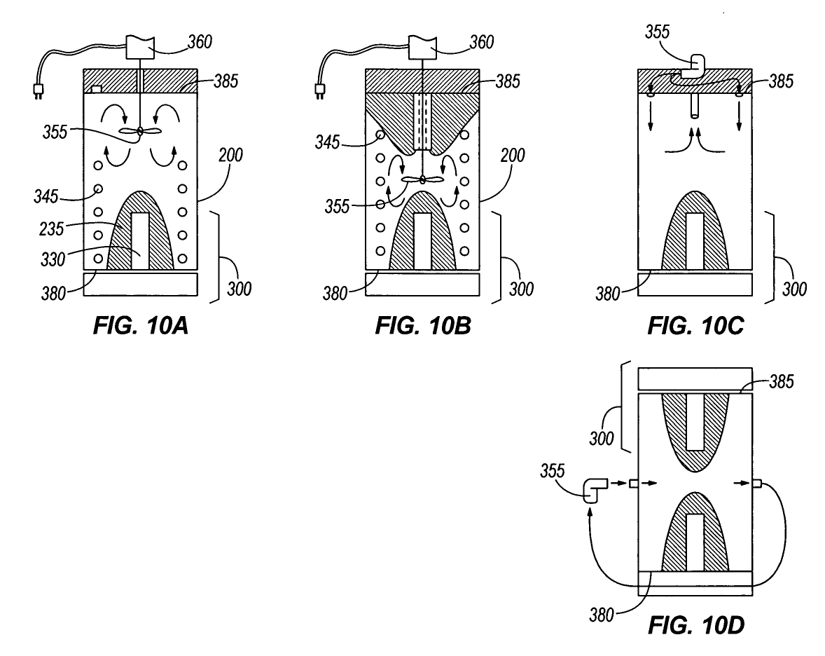

FIGS. 10A-10D illustrate embodiments of agitators 355. FIG. 10A illustrates an embodiment of the cooling reservoir 200 with a single ice forming module 300 in the bottom portion 380 of the cooling reservoir 200. A fan style agitator 355 can be driven by an agitator motor 360 positioned above the cooling reservoir 200. The agitator motor 360 can turn the agitator 355 such that the water 210 in the upper portion of the cooling reservoir 200 can be forced down over the ice 235 that has formed around the ice growing appendage 330. Since warmer water 210 will naturally rise, the agitator 355 can move the relatively warmer water 210 from the upper portion of the cooling reservoir 200 toward the ice 235 where it can be cooled. Substantially continuous agitation of the water 210 can result in the temperature of the water 210 in the cooling reservoir 200 being relatively equal throughout the entire cooling reservoir 200. Thermal outpacing generally only occurs when the thermal load on the system results in an elevation in the liquid water temperature before the system can recover and melt the solid ice mass, and thus pull the liquid temperature back down to acceptable limits. As relatively warm beverage flows through the liquid conduit 345, the water 210 in the cooling reservoir 200 can cool the beverage. This cooling of the beverage can result in warming of the water 210, as the water 210 removes the heat from the beverage. Actuation of the water 210 around the ice 235 can cause the ice 235 to cool the water 210. Thermal outpacing of the system can occur when the thermal load on the system results in an elevation in the water 210 temperature. Recovery can occur when melting of the ice 235 reduces the water 210 temperature back down to an acceptable limit. The TEC 305 can cool the ice 235 so that ice 235 that melted can be refrozen resulting in the formation of the ice 235 staying relatively consistent.

Another embodiment of the actuator 355 can run the actuator motor 360, and thus the actuator 355, only when the dispensing valve 135 is opened and beverage is flowing through the liquid conduit 345. Still another embodiment of the actuator 355 can run the actuator motor 360, and thus the actuator 355, only when the cooling capacity of the beverage dispensing tower 100 is insufficient and the red indicator LED 170 is lit.

FIG. 10B illustrates an embodiment of a stirring agitator 355 in a configuration using two ice forming modules 300, one on the top portion 385 of the cooling reservoir 200 and one on the bottom portion 380 of the cooling reservoir 200. The ice forming module 300 on the top portion 385 of the cooling reservoir 200 can result in increased cooling capacity.

FIGS. 10C and 10D illustrate embodiments of a cooling reservoir 200 using one or two ice forming modules 300. The water 210 in the cooling reservoir 200 can be agitated by a pump 392. A water inlet pipe 394 can be positioned in the cooling reservoir 200 to supply water 210 from the cooling reservoir 200 to the pump 392. The pump 392 can force the water 210 from the cooling reservoir 200 back into the cooling reservoir 200 via at least one return pipe 396. As shown in FIG. 10C, the pump 392 can be positioned above the cooling reservoir 200. The water inlet pipe 394 can draw water 210 from the center of the cooling reservoir 200 and the pump 392 can force water out through the at least one return pipe 396 along the outside walls of the cooling reservoir 200. FIG. 10D illustrates another embodiment of an agitator 355 in which the pump 392, water inlet pipe 394, and the one or more return pipes 396 can be centrally located on the cooling reservoir 200. Many different types and combinations of agitators 355 and locations of water inlet pipes 394 and return pipes 396 can be used, depending on the desired agitation and cooling properties.

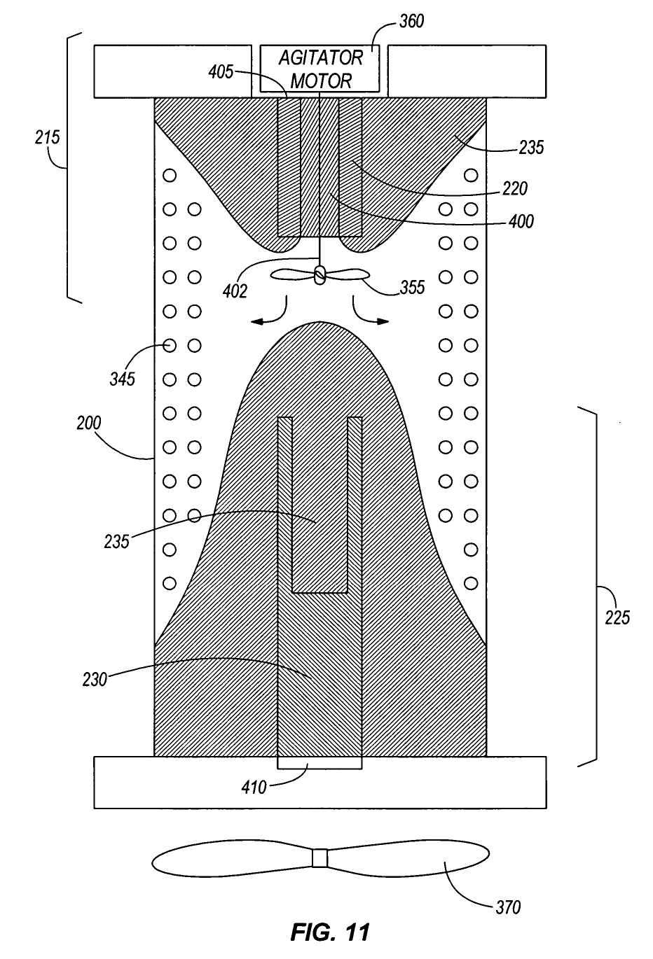

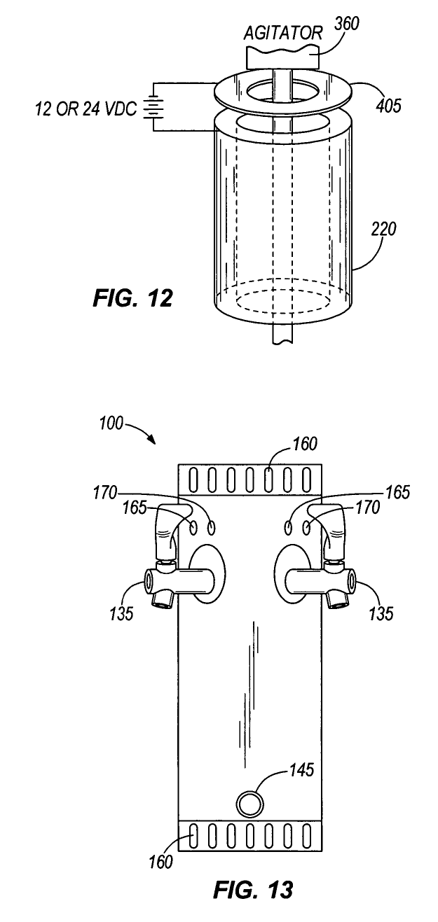

In one embodiment of the beverage dispensing tower 100, as shown in FIG. 11, two ice forming modules 300 can be used. The bottom ice forming module 225 can have a bottom ice growing appendage 230 in the shape of a hollowed-out cylinder or a blind bore (FIG. 5B) which can allow ice formation internal to the cylinder. The ice growing appendage 230 can have a height approximately equal to one half the height of the cooling reservoir 200. The top ice forming module 215 can have a top ice growing appendage 220 in the shape of a tube (FIG. 5C) and a height approximately equal to one quarter the height of the cooling reservoir 200. The center of the top ice growing appendage 220 can include a thermally-insulating tube 400. A shaft 402 of an agitator 355 can extend through the thermally-insulating tube 400. An agitator motor 360 positioned above the cooling reservoir 200 can drive the agitator 355. As shown in FIG. 12, in one embodiment, a donut-shaped TEC 305 can be used to accommodate the shaft 402 of the agitator 355. A heat sink 320 for the TEC 305 can include a circular opening to accommodate the agitator motor 360 and shaft 402 of the agitator 355. Two concentric coils of a liquid conduit 345 can be positioned within the cooling reservoir 200. The liquid conduit 345 can be constructed of stainless steel and can be 13.5 meters long and have an inside diameter of 5 mm and an outside diameter of 6 mm. The volume of the liquid conduit 345 can be approximately 0.26 liters. The volume of the cooling reservoir 200 can be approximately 2.98 liters. The volume of the cooling reservoir 200 available for water 210 and ice 235 after the ice growing appendages 330, agitator 355, and liquid conduit 345 have been installed can be 2.3 liters. Ice 235 can form around and within the bottom ice growing appendage 230 filling substantially the entire base of the cooling reservoir 200 with ice 235 and extending away from the walls of the cooling reservoir 200 as the ice 235 gets farther away from the lower TEC 305. A formation of ice 235 can surround the top ice growing appendage 220 and can extend from the walls of the cooling reservoir 200 to the insulation tube 400 within the top ice growing appendage 220.

In some embodiments of the ice growing appendage 330, surface coating an inner surface of the upper ice growing appendage 330 with very smooth media (such as, but not limited to, Teflon®) can control the surface tolerance on smoothness to a point where ice will not nucleate due to the smoothness of the surface. In other words, the smoothness of particular surfaces of the ice growing appendage 330 can inhibit the formation of ice 235 on those surfaces.

Some embodiments of the beverage dispensing tower 100 can include multiple dispensing valves 135, as shown in FIG. 13. A separate inlet coupling 140 and liquid conduit 345 can be used for each dispensing valve 135.

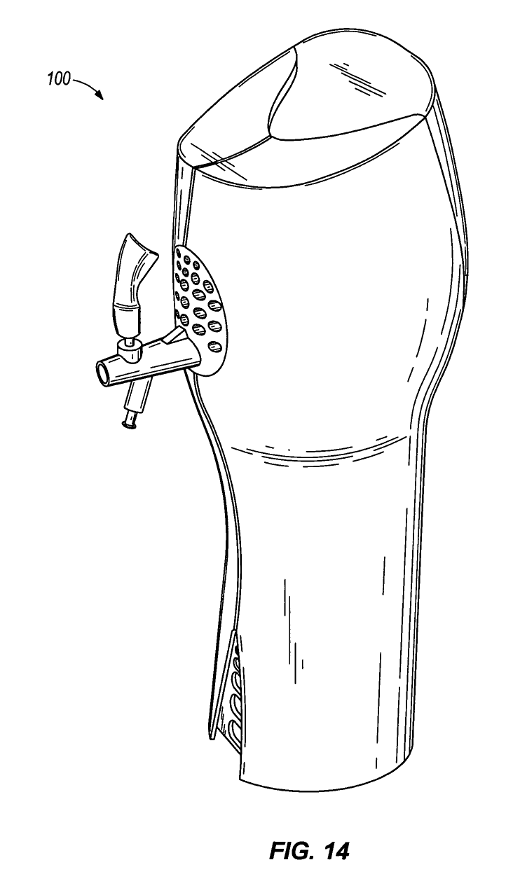

FIG. 14 illustrates a perspective view of an embodiment of the beverage dispensing tower 100 that can be installed above a counter or a bar. In some embodiments, the size of the beverage dispensing tower 100 can be consistent with conventional beverage dispensing geometries. Other embodiments can allow for installation below a counter or a bar.

To improve the thermal efficiency of the beverage dispensing tower 100, heat pipes can be used in some embodiments to transfer the cooling capacity from the TEC 305 to the water 210 within the cooling reservoir 200. Heat pipes can also be used to result in a system where the solid ice zone and the liquid water zone are separate chambers that exchange energy only through a heat pipe that commutes from one zone to the other. This can allow for a system that generally does not ice or freeze the beverage coils.

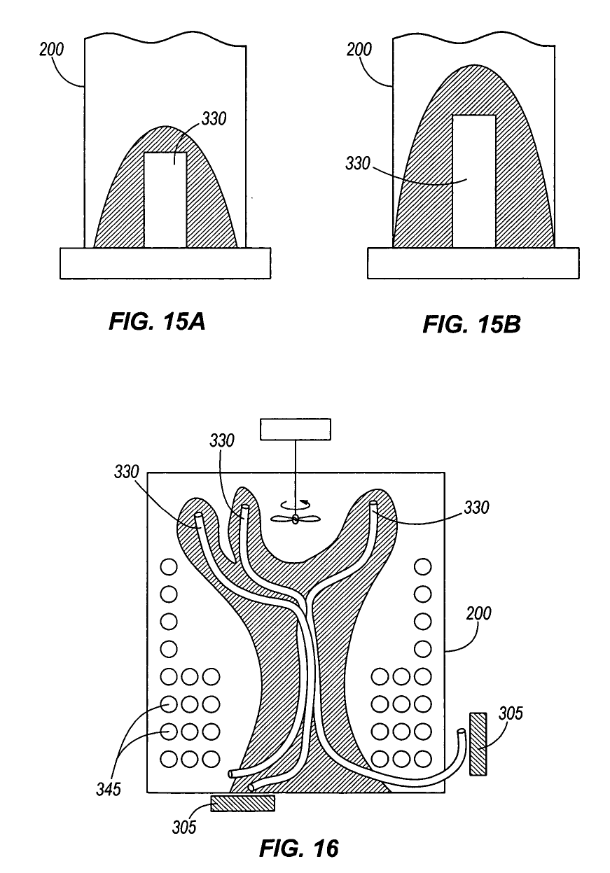

FIGS. 15A and 15B illustrate embodiments of cooling reservoirs 200. FIG. 15A illustrates an embodiment including an ice growing appendage 330 constructed of a material such as aluminum. FIG. 15B illustrates an embodiment including an ice growing appendage 330 in the form of a heat pipe. The thermal characteristics of a heat pipe ice growing appendage 330 can enable the ice growing appendage 330 of FIG. 15B to be of a length that is substantially longer than that possible with ice growing appendage 330 of FIG. 15A constructed with other materials such as aluminum.

In other embodiments, the cooling reservoir 200 can have a separate ice chamber and a separate water chamber. A heat pipe can exchange energy between the ice chamber and the water chamber.

FIG. 16 illustrates an embodiment of the cooling reservoir 200 in which the ice growing appendage 330 can be in the form of multiple heat pipes (e.g., three). The ice growing appendages 330 can take on many more shapes and can more efficiently transfer cooling capacity to their extremities. As shown in FIG. 16, this can result in ice growing appendages 330 in which the geometry of the ice 235 can be more easily controlled. This ability to control the geometry of the ice 235 can allow the liquid conduit 345 to be positioned in the lower portion of the cooling reservoir 200 where the water 210 can be kept the coldest.

Some embodiments of the beverage dispensing tower 100 can include circuitry to control the TEC 305. In some embodiments, sensors in the cooling reservoir 200 can detect volumetric expansion related to ice formation enabling the TECs 305 to be controlled to achieve desired ice 235 volumes.

The beverage dispensing tower 100 can be modified to dispense warm beverages by positioning the second warm side 315 of the TEC 305 in thermal communication with the ice growing appendage 330 and the first cool side 310 of the TEC 305 in thermal communication with the heat sink 320. The liquid in the cooling (now heating) reservoir 200 could be heated by the TEC 305 and could transfer that heat to the beverage within the liquid conduit 345.

One embodiment of the invention can include the following structural characteristics: total system internal volume of about 2.98 liters (i.e., total internal volume of the cylinder not reduced for the aluminum ice generating appendage and beverage coils); total wetted internal volume of about 2.3 liters (i.e., total volume of ice and water); beverage coil geometry for a stainless steel beverage coil having a length of about 13.5 meters, an inner diameter of about 5 millimeters, an outer diameter of about 6 millimeters, and a total internal volume of about 0.26 liters. One embodiment of the invention can have the following performance characteristics: beverage inlet temperature of about 17° C. (about 63° F.); delivery or dispensing temperature of about 4 to 8° C.; a dispensing volume of about 22 liters; dispensing doses of about 0.3 liters, about 0.5 liters, and about 1.0 liter; dwell time between doses of about 10 to 15 seconds or less; and period of dispense of about 35 minutes. In some embodiments, twice the intended daily maximum output (i.e., 10 liters) can be run through the system continuously without thermally outpacing the system (e.g., all beverage dispensed is within the desired delivery temperature of 4 to 8° C.). In some embodiments, the system can melt ice at an equilibrium rate that meets the thermal demand with a beverage inlet temperature of about 17° C. (i.e., water temperature does not rise and ice melts). With an inlet beverage temperature of about 27°, system performance may be reduced and the onset of time dwell between dispenses may occur.

In some embodiments, the system can have one or more of the following minimum performance specifications: open tap flow rate of about 3 liters per minute; inlet beverage temperature of about 20° C.; outlet beverage temperature of about 5° C.; maximum total dispense volume per day of about 10 liters; and recharge time for ice-bank of about 8 hours. Some embodiments of the system can perform according to the following sequence: (1) dispense two 0.3 liter beverages poured over a 25 second period (e.g., 0.3 liters in 6 seconds, 13 seconds no flow, and 0.3 liters in 6 seconds); (2) dwell period of 40 seconds with no flow; (3) repeat steps (1) and (2); and (4) after four minutes of no flow, cycle (1) through (3) (i.e., four 0.3 liter beverages over a 130 second profile).

Various features and advantages of the invention are set forth in the following claims.

1. A liquid cooling and dispensing system, the system comprising:
a liquid source;
a cooling reservoir;
a dispensing valve; and
a liquid conduit connecting the liquid source to the dispensing valve, the liquid conduit being constructed of a thermally-conductive material, the liquid conduit passing through the cooling reservoir.

2. The system of claim 1 and further comprising a thermoelectric cooler.

3. The system of claim 1 and further comprising a liquid dispensing tower including the cooling reservoir.

4. The system of claim 1 and further comprising a site tube coupled to the cooling reservoir and indicating a level of at least one of a cooling liquid and ice in the cooling reservoir.

5. The system of claim 1 and further comprising a sensor that detects the level of cooling liquid in the cooling reservoir.

6. The system of claim 5 wherein the sensor is coupled to an indicator to display an indication when the level of cooling liquid is low.

7. The system of claim 1 and further comprising a drain plug coupled to a base of the cooling reservoir.

8. The system of claim 1 and further comprising a plurality of liquid conduits coupled to a plurality of liquid sources and coupled to a plurality of dispensing valves.

9. The system of claim 1 and further comprising a temperature sensor to sense the temperature of the cooling liquid and an indicator to display a signal when the cooling liquid is above a predetermined temperature threshold.

10. The system of claim 1 and further comprising an agitator positioned in the cooling reservoir.

11. The system of claim 10 wherein the agitator operates when the dispensing valve is open.

12. The system of claim 10 wherein the agitator operates when the temperature of the cooling liquid exceeds a threshold.

13. A method of cooling a liquid, the method comprising:
positioning a dispensing valve adjacent a cooling reservoir;
at least partially filling the cooling reservoir with cooling liquid;
freezing a portion of the cooling liquid in the cooling reservoir;
pumping a liquid through a thermo conductive conduit positioned in the cooling reservoir; and
cooling the liquid as it passes through the thermo conductive conduit.

14. The method of claim 13 and further comprising indicating when a cooling capacity is not sufficient to cool the liquid to a predetermined temperature.

15. The method of claim 13 and further comprising agitating the cooling liquid to improve a cooling capacity.

16. A method of providing cooled liquids to a dispensing valve, the method comprising:
maintaining ice and water in a cooling reservoir near the dispensing valve;
pumping liquid through a thermo conductive conduit positioned in the ice and water; and
pumping the liquid out of the dispensing valve.

17. The method of claim 16 and further comprising indicating when a cooling capacity is not sufficient.

18. The method of claim 16 and further comprising agitating the water to improve a cooling capacity.

19. A liquid distribution system, the system comprising:
a cooling reservoir at least partially filled with a cooling liquid;
an insulating material coupled to the cooling reservoir;
an ice forming module including a thermoelectric cooler and an ice growing appendage, the ice growing appendage positioned in the cooling reservoir in thermal communication with the cooling liquid; and
a liquid conduit positioned in the cooling reservoir, the liquid conduit coupled to a liquid inlet and a dispensing valve.

20. The system of claim 19 and further comprising an agitator positioned in the cooling reservoir.

21. The system of claim 19 wherein the ice forming module is coupled to a bottom portion of the cooling reservoir.

22. The system of claim 19 wherein the ice forming module is coupled to a top portion of the cooling reservoir.

23. The system of claim 19 wherein the ice growing appendage is a semi-hollow cylindrical shape.

24. The system of claim 23 wherein the cooling liquid within the interior of the ice growing appendage freezes.

25. The system of claim 20 wherein the agitator operates only when the dispensing valve is in an open position.

26. The system of claim 19 and further comprising a temperature sensor that detects when the cooling liquid is above a predetermined temperature.

27. The system of claim 26 further comprising an indicator coupled to the temperature sensor and configured to light when the temperature sensor detects that the cooling liquid is above the predetermined temperature.

28. The system of claim 26 and further comprising an indicator coupled to the temperature sensor and configured to light when the temperature sensor detects that the cooling liquid is below the predetermined temperature.

29. The system of claim 19 wherein the ice growing appendage is a heat pipe.

30. The system of claims 20 wherein the agitator operates only when the cooling liquid is above a predetermined temperature.

31. A liquid distribution system, the system comprising:
a cooling reservoir at least partially filled with a cooling liquid;
an insulating material coupled to the cooling reservoir;
a first ice forming module including a first thermoelectric cooler and a first ice growing appendage, the first ice growing appendage positioned in an upper portion of the cooling reservoir in thermal communication with the cooling liquid;
a second ice forming module including a second thermoelectric cooler and a second ice growing appendage, the second ice growing appendage positioned in a lower portion of the cooling reservoir in thermal communication with the cooling liquid; and
a liquid conduit positioned in the cooling reservoir, the liquid conduit coupled to a liquid inlet and a dispensing valve.

32. The system of claim 31 and further comprising an agitator positioned in the cooling reservoir.

33. The system of claim 31 wherein the second ice growing appendage is a semi-hollow shape.

34. The system of claim 31 wherein the first ice growing appendage is a tube shape.

35. The system of claim 34 and further comprising an insulating tube inside the first ice growing appendage.

36. The system of claim 35 and further comprising an agitator shaft extending through the insulating tube.

37. The system of claim 31 wherein the liquid conduit includes concentric coil.

38. The system of claim 31 wherein the liquid conduit includes dual concentric coils.

39. The system of claim 31 wherein the liquid conduit includes triple concentric coils.

40. The system of claim 31 wherein the cooling liquid within the interior of the second ice growing appendage freezes.

41. The system of claim 32 wherein the agitator operates only when the dispensing valve is in an open position.

42. The system of claim 31 and further comprising a temperature sensor to detect when the cooling liquid is above a predetermined temperature.

43. The system of claim 42 and further comprising an indicator coupled to the temperature sensor and configured to light when the temperature sensor detects that the cooling liquid is above the predetermined temperature.

44. The system of claim 42 and further comprising an indicator coupled to the temperature sensor and configured to light when the temperature sensor detects that the cooling liquid is below the predetermined temperature.

45. The system of claim 32 wherein the agitator operates only when the cooling liquid is above the predetermined temperature.
